(19) United States
(12) Patent Application Publication
(10) Pub. No.: US 2026/0093589 A1
(43) Pub. Date: Apr. 2, 2026

(54) METHOD AND APPARATUS FOR ANALYZING OPERATION MODE OF APPLICATION PLATFORM

(71) Applicant: Winbond Electronics Corp., Taichung City (TW)

(72) Inventors: Tzi-Wen Pan, Hsinchu (TW); You-Ming Yong, Hsinchu County (TW); Cheng-Hao Lin, Hsin-Chu (TW)

(73) Assignee: Winbond Electronics Corp., Taichung City (TW)

(21) Appl. No.: 19/313,866

(22) Filed: Aug. 29, 2025

(30) Foreign Application Priority Data
Sep. 30, 2024 (TW) 113137332

(51) Int. Cl. G06F 11/30; G06F 11/34

(52) U.S. Cl. CPC G06F 11/3068; G06F 11/3419; G06F 11/3452

(57) ABSTRACT

A method and an apparatus for analyzing an operation mode of an application platform are provided. The method includes following steps: capturing operation signals generated by the application platform performing operations on a product, and converting the operation signals into a command sequence in a text form; defining multiple operation combinations operated by the application platform on the product as target sentences to establish a sentence finding map according to a data sheet of the product; scanning the command sequence by using N-gram algorithm according to each target sentence in the sentence finding map to find multiple command sentences in the command sequence that match the target sentence; and calculating multiple time parameters of each command sentence and performing statistics on the command sentences, and outputting a statistical result of each command sentence in time series to simulate the operation mode of the application platform in each time series.

### CROSS-REFERENCE TO RELATED APPLICATION

This application claims the priority benefit of Taiwan application serial no. 113137332, filed on September 30, 2024. The entirety of the above-mentioned patent application is hereby incorporated by reference herein and made a part of this specification.

### BACKGROUND

### Technical Field

The disclosure relates to an analyzing method and an apparatus, and in particular relates to a method and an apparatus for analyzing an operation mode of an application platform.

### Description of Related Art

Most application platforms use firmware or software to issue commands to the integrated circuits on the board to achieve the desired purpose. Therefore, for test engineers, when confronted with failures and customer returns related to application platforms, if they wish to ascertain why the integrated circuits on the application platform have failed, they must first comprehend how the integrated circuits are operated on the board. Specifically, they must understand which commands were issued by the application platform.

To achieve this goal, a common practice is for test engineers to use a logic analyzer to capture command signals when the application platform operates. These signals often contain long stretches of continuous and complex information. Even if only 1 millisecond (ms) signal is captured and each clock is regarded as a command, a continuous and complex command sequence with a length of more than one million lines will still be obtained. If we consider each command as a word, we would obtain an article with over one million words, lacking a discernible beginning, paragraphs, and punctuation. Confronted with such a voluminous quantity of information, should engineers attempt to interpret it solely based on their personal experience through manual methods, it is inevitable that omissions would occur or that they would be unable to comprehend the entirety of the content.

### SUMMARY

An application platform operation mode analyzing method and apparatus, which use N-gram to analyze operation command information captured from the application platform, and may scan meaningful command information, are provided in the disclosure.

Embodiments of the disclosure provide an application platform operation mode analyzing method, which is suitable for an electronic device having a processor. The method includes following operation. Operation signals generated by the application platform performing operations on a product are captured, and the operation signals are converted into a command sequence in a text form. Multiple operation combinations operated by the application platform on the product are defined as target sentences to establish a sentence finding map according to a data sheet of the product. The command sequence are scanned by using N-gram algorithm according to each target sentence in the sentence finding map to find multiple command sentences in the command sequence that match the target sentences. Multiple time parameters of each command sentence are calculated and statistics are performed on the command sentences, and a statistical result of each command sentence is output in time series to simulate the operation mode of the application platform in each time series.

Embodiments of the disclosure provide an application platform operation mode analyzing apparatus, which includes a test data capturing device, a storage device, and a processor. The test data capturing device is configured to capture the operation signals generated by the application platform performing operations on a product. The processor is coupled to the test data capturing device and the storage device, and is configured to convert the operation signals captured by the test data capturing device into a command sequence in a text form. Multiple operation combinations operated by the application platform on the product are defined as target sentences to establish a sentence finding map according to a data sheet of the product and store the sentence finding map in the storage device. The command sequence are scanned by using N-gram algorithm according to each target sentence in the sentence finding map to find multiple command sentences in the command sequence that match the target sentence. Multiple time parameters of each command sentence are calculated and statistics are performed on the command sentences, and a statistical result of each command sentence is output in time series to simulate the operation mode of the application platform in each time series.

Based on the above, in the application platform operation mode analyzing method and apparatus of the disclosure, by finding and classifying into statistics various sentences of different definitions and lengths within the command sequence, and calculating various time parameters, it is possible to understand the structure of the command sequence and the important operation modes. In addition, by calculating various time parameters of the command sentence and performing statistics, it may be known whether there are violations of component timing or other specifications during the operation of the application platform. Based on this statistical result, the command sentence may be converted into a test program suitable for testing the product by the application platform, thereby increasing the test coverage.

### BRIEF DESCRIPTION OF THE DRAWINGS

FIG. 1 is a schematic diagram of an application platform operation mode analyzing method according to an embodiment of the disclosure.

FIG. 2 is a block diagram of an application platform operation mode analyzing apparatus according to an embodiment of the disclosure.

FIG. 3 is a flowchart of an application platform operation mode analyzing method according to an embodiment of the disclosure.

FIG. 4 is a schematic diagram of a data cube for establishing a command sequence according to an embodiment of the disclosure.

FIG. 5 is a schematic diagram of selecting a target sentence to scan a command sequence according to an embodiment of the disclosure.

FIG. 6 is a schematic diagram of selecting a target sentence to scan a command sequence according to an embodiment of the disclosure.

FIG. 7 is a statistical table of sentence patterns according to an embodiment of the disclosure.

FIGS. 8A to 8D are examples of calculating time parameters and using them to determine operating status according to embodiments of the disclosure.

FIGS. 9A to 9F are examples of statistical results of time parameters according to embodiments of the disclosure.

### DETAILED DESCRIPTION OF DISCLOSED EMBODIMENTS

The embodiment of the disclosure pertains to a method for "reading" operation command information captured from an application platform. This method employs the N-gram algorithm from natural language processing to construct a means of reading said information. This enables engineers to directly comprehend the operational procedures of the application platform through a reader, thereby enhancing the efficiency and accuracy of analysis.

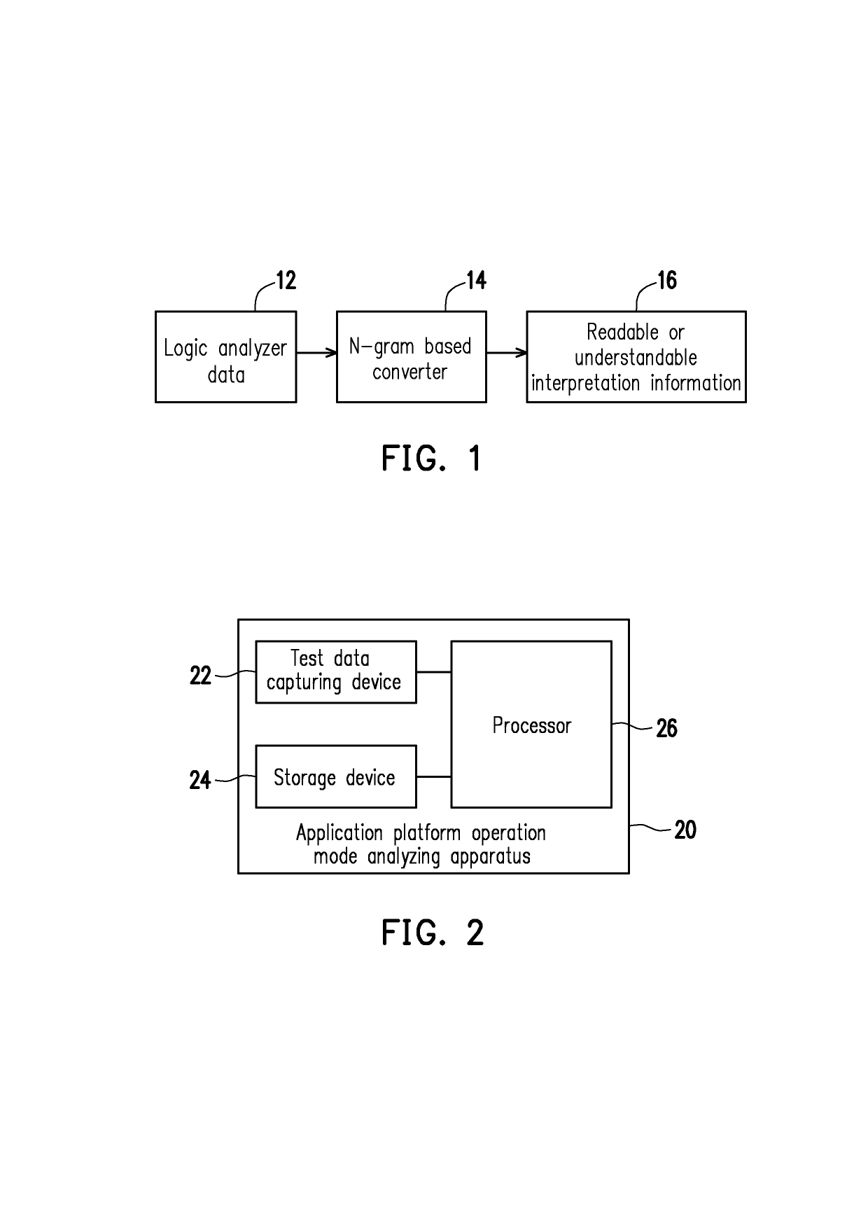

FIG. 1 is a schematic diagram of an application platform operation mode analyzing method according to an embodiment of the disclosure. Referring to FIG. 1, in this embodiment, the analyst first uses a logic analyzer (LA) to capture the operation signals of the product to be analyzed on the application platform to generate logic analyzer data 12. Then, according to the data sheet of the product, multiple operation combinations for the product are defined as target sentences, and the logic analyzer data 12 is scanned using an N-gram based converter 14 to generate readable or understandable interpretation information 16 for engineers. Finally, presenting this interpretation information 16 through time statistics or characteristic diagrams may help engineers understand the operating environment of the product and whether there are violations of component specifications during the operation process when analyzing the operation mode of the application platform.

FIG. 2 is a block diagram of an application platform operation mode analyzing apparatus according to an embodiment of the disclosure. Referring to FIG. 2, the application platform operation mode analyzing apparatus 20 of this embodiment is, for example, an electronic device such as a file server, a database server, an application server, a workstation or a personal computer with computing capabilities, which includes a test data capturing device 22, a storage device 24, and a processor 26. The functions of each component are described as follows.

The test data capturing device 22 is, for example, a logic analyzer or an oscilloscope or other test information capturing device used to capture operation signals when the application platform is operated. This embodiment does not limit its type.

The storage device 24 is, for example, any type of fixed or removable random access memory (RAM), read only memory (ROM), flash memory, hard disk and other recording media, which may be used to store computer programs that may be executed by the processor 36 and data generated by the processor 36, including the command sequence, data cube, sentence finding map, etc. described below. This embodiment does not limit the type of data stored therein.

The processor 26 is, for example, a central processing unit (CPU), or other programmable general-purpose or special-purpose microprocessor, a micro controller, a digital signal processor, a programmable controller, an application specific integrated circuit, a programmable logic device, or other similar devices, or a combination of these devices, the disclosure is not limited thereto. In this embodiment, the processor 26 may load a computer program from the storage device 24 to execute the application platform operation mode analyzing method of the embodiment of the disclosure.

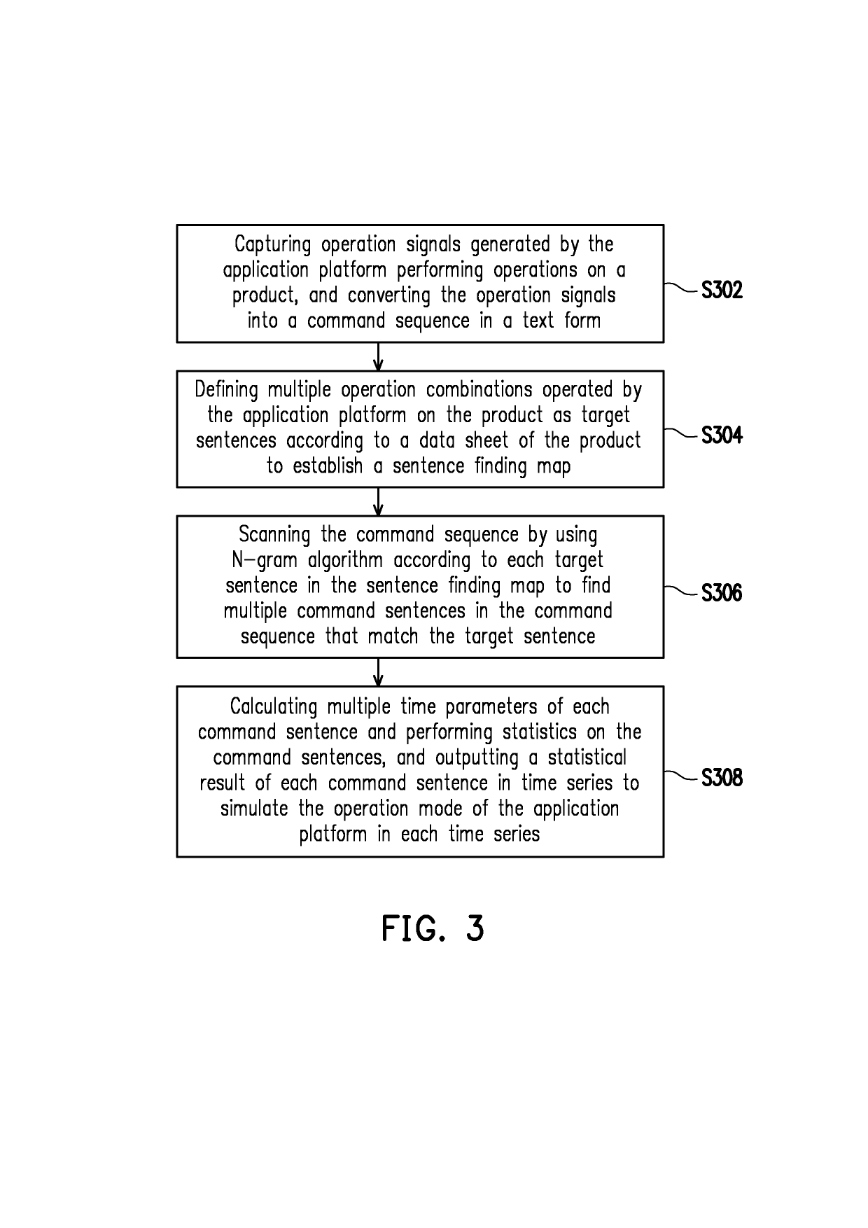

FIG. 3 is a flowchart of an application platform operation mode analyzing method according to an embodiment of the disclosure. Referring to FIGS. 2 and 3 at the same time, the method of this embodiment is applicable to the application platform operation mode analyzing apparatus 20 shown in FIG. 2. The detailed steps of the method of this embodiment are described below with reference to various components in the application platform operation mode analyzing apparatus 20.

In step S302, the processor 26 of the application platform operation mode analyzing apparatus 20 captures the operation signals generated by the application platform performing operations on the product, and converts the operation signals into a command sequence in a text form. In one embodiment, the processor 26 uses a test data capturing device 22 such as a logic analyzer or an oscilloscope to capture the operation signals of the product to be analyzed on the application platform, and then converts the captured operation signals into a command sequence in a text form.

Depending on the product to be analyzed and the test data capturing device 22 used, the captured operation signals will be different. In one embodiment, the processor 26 may convert the captured operation signals into a clock-based command sequence according to the definition of operation commands of each product. Taking the third generation double data rate synchronous dynamic random access memory as an example, its main operation signals include CS, CAS, RAS, etc., and the processor 26 may convert these operation signals into commands such as ACT, WRITE, and READ according to the command truth table.

In one embodiment, in addition to the command pins, the component operation also has address signal pins. The address information may be assembled according to the signals captured from these pins, and the address information may be combined into a clock-based data with operation commands and address information according to the clock.

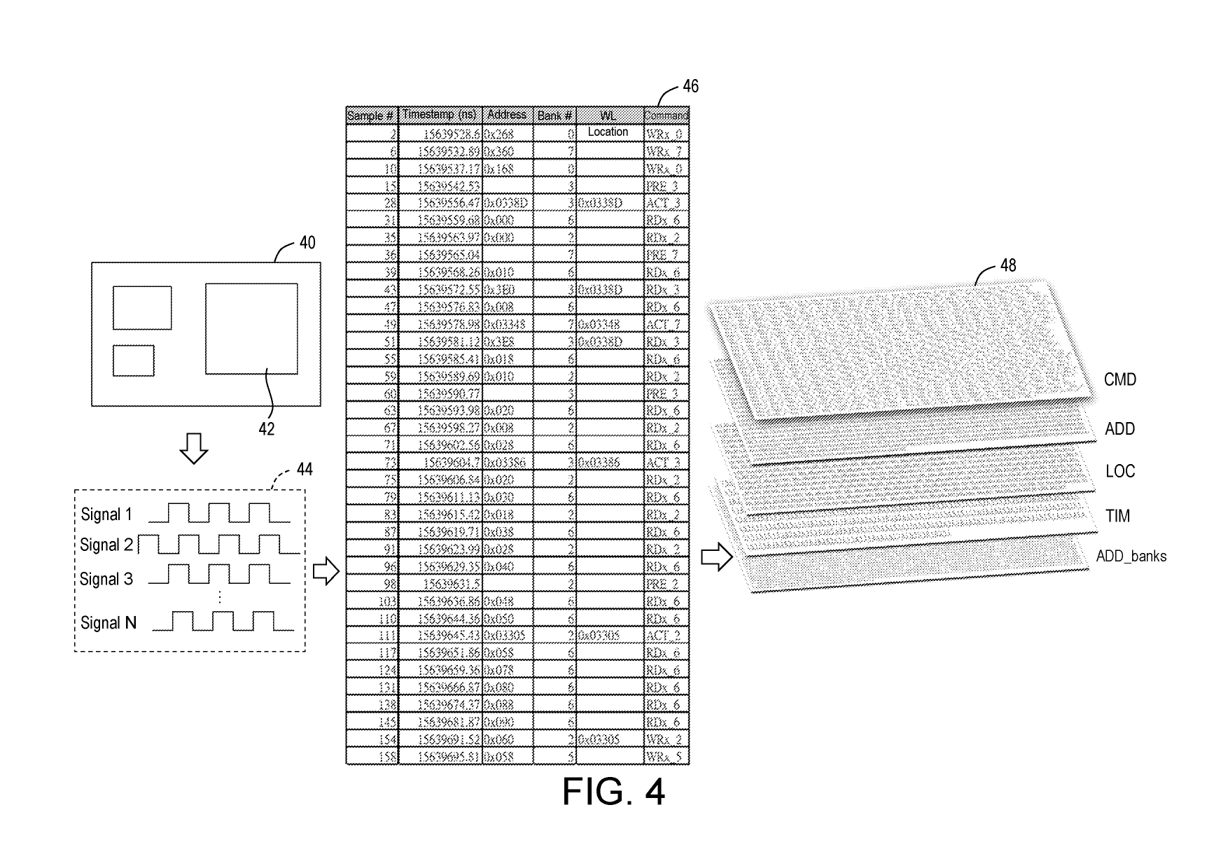

For example, FIG. 4 is a schematic diagram of a data cube for establishing a command sequence according to an embodiment of the disclosure. Referring to FIG. 4, in this embodiment, the application platform 40 executes the application program to operate the product to be tested 42 configured thereon. Next, a logic analyzer or an oscilloscope is sued to capture the operation signals 44 (including signals 1 to N) generated by the application platform when operating the product, and then the operation signals 44 are converted into a command sequence 46 in text form. The converted command sequence may be respectively added to multiple data layers in the data cube 48 according to the type of the operation signal (including command, address, location or timing, etc.), such as command layer CMD, address layer ADD, location layer LOC, timing layer TIM, memory bank layer ADD_banks, etc., finally establishing a data cube 48 including multiple data layers.

In step S304, the processor 26 defines multiple operation combinations for operating the product by the application platform as target sentences according to the data sheet of the product to establish a sentence finding map, and stores the sentence finding map in the storage device 24. Each target sentence includes at least one of a head command, a tail command, and a middle command. This embodiment does not limit its composition.

Specifically, in natural language processing (NLP), each word is referred to as a token. Based on the same concept, this embodiment may convert the data captured by the logic analyzer into an "article" for processing, and treat each "command" as a token. Based on the data sheet of the product, the writing form and grammar of this "article" may be known. For example, according to the data sheet of dynamic random access memory (DRAM), it may be known that in its reading and writing grammar, the head of the most basic "command sentence" must be the "ACT" command of a certain memory bank, and the tail must be the "PRE" or "PREA" command of the memory bank.

In step S306, the processor 26 scans the command sequence by using an N-gram algorithm according to each target sentence in the sentence finding map to find multiple command sentences in the command sequence that match the target sentence. In one embodiment, the processor 26 selects one of the target sentences and scans the command sequence by using a rolling window whose width is sequentially adjusted to find command sentences in the rolling window that matches the selected target sentence, and adds the command sentence to the command sentence group. The processor 26 will repeatedly execute the above steps of selecting the target sentence and scanning the command sequence until the command sentence in the command sentence group reaches the predetermined condition, which terminates the scan. The above-mentioned predetermined condition is, for example, that the command sentences in the command sentence group are not added or changed after a predetermined time or a predetermined scanning number, but this embodiment is not limited thereto.

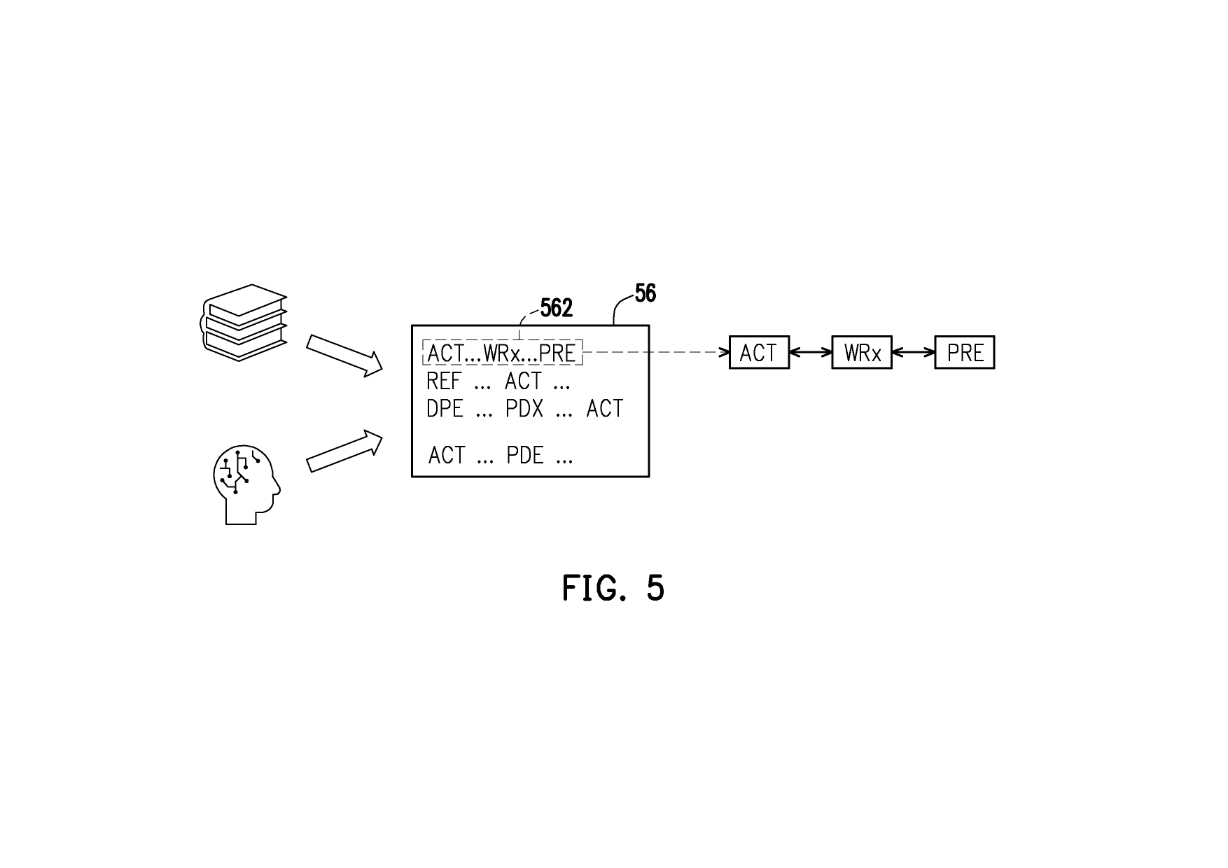

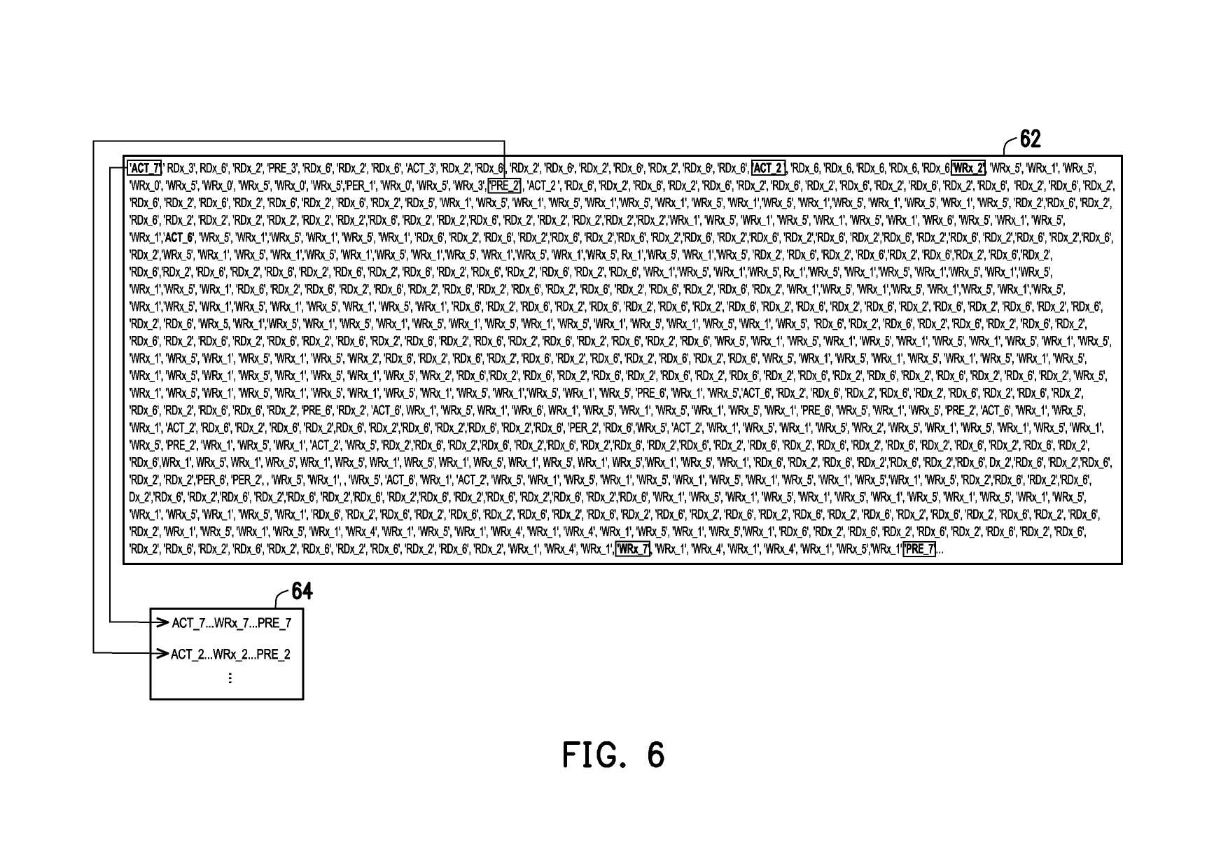

For example, FIGS. 5 and 6 are schematic diagrams of selecting a target sentence to scan a command sequence according to an embodiment of the disclosure. Referring to FIG. 5 first, in this embodiment, the basic combination 52 of the legal operation of the product and the special combination 54 of the operation mode that the engineer intends to analyze (which may be illegal operations) are put into the target sentence box 56 as the target sentence according to the data sheet of the product to establish a sentence finding map. For example, in the target sentence box 56, the head of the target sentence 562 is the "ACT" command, the middle is the "WRx" command, and the tail is the "PRE" command. According to the target sentence 562, this embodiment, for example, increases the width of the rolling window sequentially from 2 to N to scan the command sequence 62.

Referring to FIG. 6, during the process of scanning the command sequence 62, if any command sentence selected (by the rolling window) matches the head command "ACT" and the tail command "PRE" set in the target sentence 562, then this command sentence is added to the command sentence group. For example, when the command sentence includes the command "ACT_7", the middle command "WRx_7" and the tail command "PRE_7", the command sentence may be added to the command sentence group 64; when the command sentence includes the command "ACT_2", the middle command "WRx_2" and the tail command "PRE_2", the command sentence may be added to the command sentence group 64. This embodiment repeats the above-mentioned actions of selecting the target sentence, adjusting the width of the rolling window, and scanning the command sequence 62, until no new command sentences are added to the command sentence group 64, at which point the scanning of the command sequence 62 is terminated.

As can be seen from the embodiments shown in FIGS. 5 and 6, in the target sentence box 56, the target sentence 562 begins with the "ACT" command, progresses through the "WRx" commands, and ends with the "PRE" command. Based on target sentence 562, the embodiment of the present application sequentially increases the width of the rolling window from 2 to N to scan command sequence 62. During the scanning of command sequence 62, if a selected command (by the rolling window) matches the head command "ACT," middle commands "WRx," and tail command "PRE" specified in the target sentence 562, the command is added to the command sentence group. For example, if an command sentence includes command "ACT_7," middle commands "WRx_7," and tail commands "PRE_7," the command sentence is added to command sentence group 64; if an command sentence includes command "ACT_2," middle commands "WRx_2," and tail commands "PRE_2," the command sentence is added to command sentence group 64. The present application defines the various ways in which the application platform can perform on the product by "combining multiple operations performed by the application platform on the product into target sentences" through "different combination sequences of the head, middle, and tail commands", thereby learning about the important operating methods of the application platform.

Returning to the flow of FIG. 3, in step S308, the processor 26 calculates multiple time parameters of each command sentence and performs statistics on the command sentences, and outputs a statistical result of each command sentence in time series to simulate the operation mode of the application platform in each time series. The above statistical results include the number or frequency of appearance of each command sentence, but this embodiment is not limited thereto. The processor 26 may refer to the definition of each time parameter of each component in the data sheet to calculate each time parameter in the found command sentence according to the found command sentence and perform statistics. Through the statistical results, we may know whether there are any violations of the component timing specification during these complex operations, and may present the operation status of the entire application platform in each sequence through timing statistics of command sentences.

Specifically, in one embodiment, the processor 26 may count the number of times each command sentence is scanned, and sort the command sentences according to the calculated number of times to find important operation modes in the command sequence.

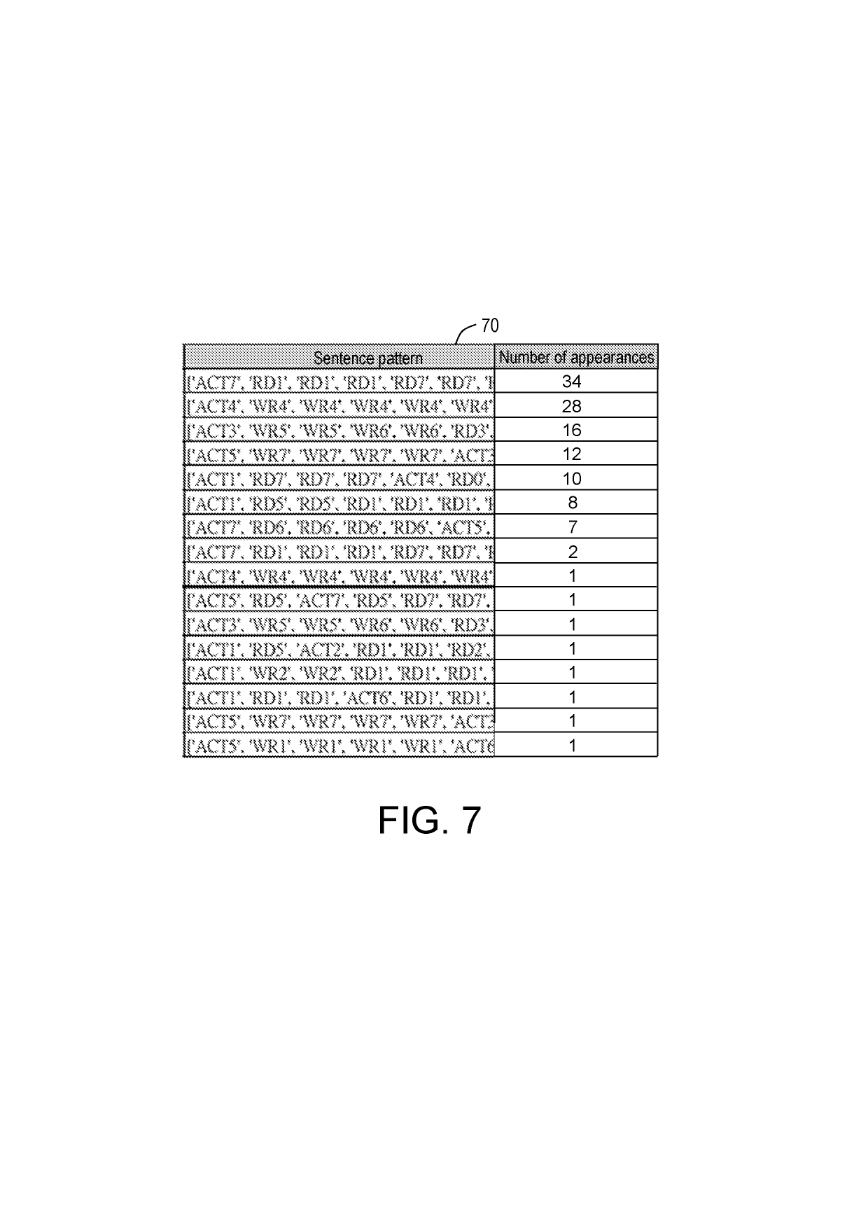

For example, FIG. 7 is a statistical table of sentence patterns according to an embodiment of the disclosure. Referring to FIG. 7, the sentence pattern statistics table 70 lists the sorting results of sentence patterns obtained by scanning the command sequence according to target sentences of different lengths. Among them, the sentence patterns in the sentence pattern statistics table 70 are sorted according to the number of times they appear in the command sequence. Therefore, engineers may find out the important operation modes in the command sequence based on the number of times each sentence pattern appears.

This embodiment, through the above method, finds and classifies various sentences with different definitions and lengths within the command sequence. Consequently, based on the number or frequency of appearance of command sentences of varying lengths, it is possible to find the important operation modes or understand the structure of the command sequence.

In one embodiment, the processor 26 may calculate multiple time parameters of each command sentence, and determine whether the application platform violates the component specifications of the product when performing operations on the product according to the calculated time parameters. The above time parameters include the RAS to CAS delay (tRCD), the CAS to CAS delay (tCCD), the read to precharge time (tRTP), the RAS active time (tRAS), the write recovery time (tWR), or the RAS precharge time (tRP), etc., of the dynamic random access memory (DRAM). This embodiment does not limit its type.

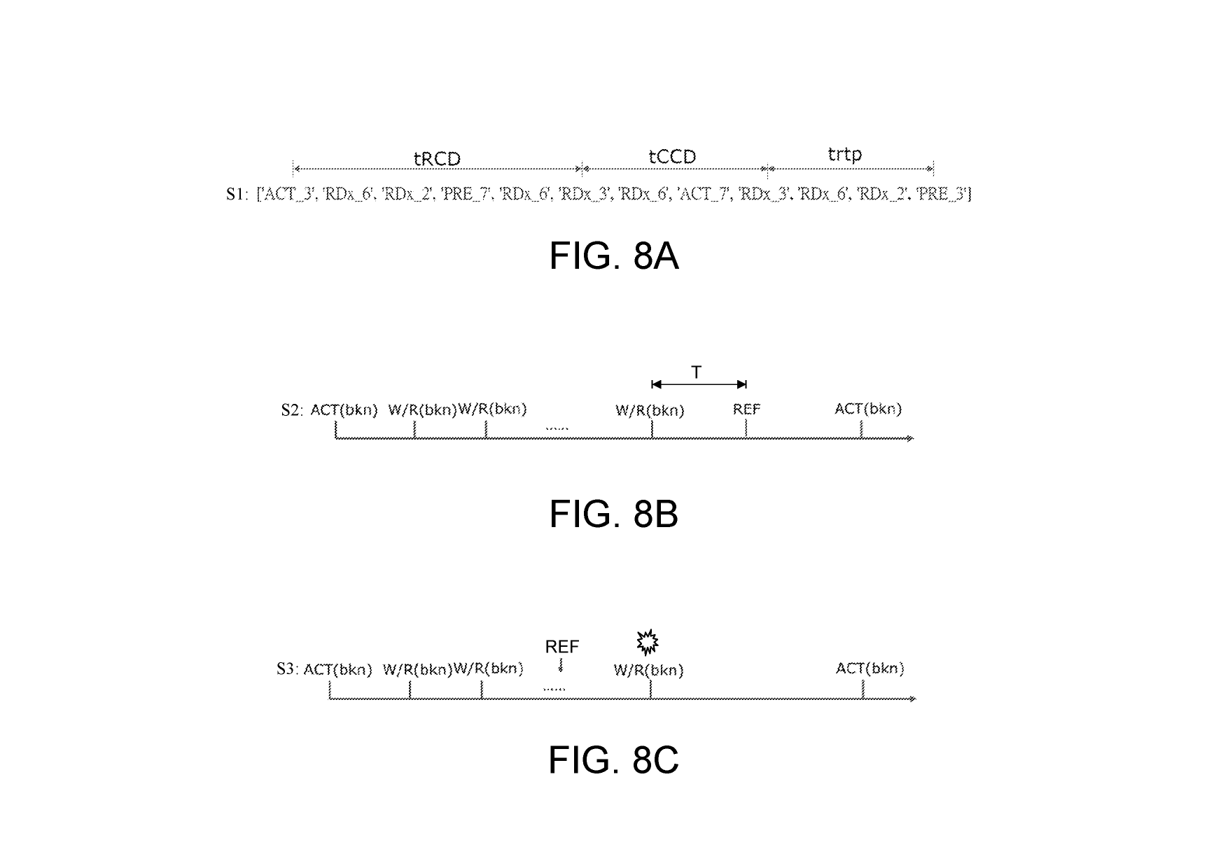

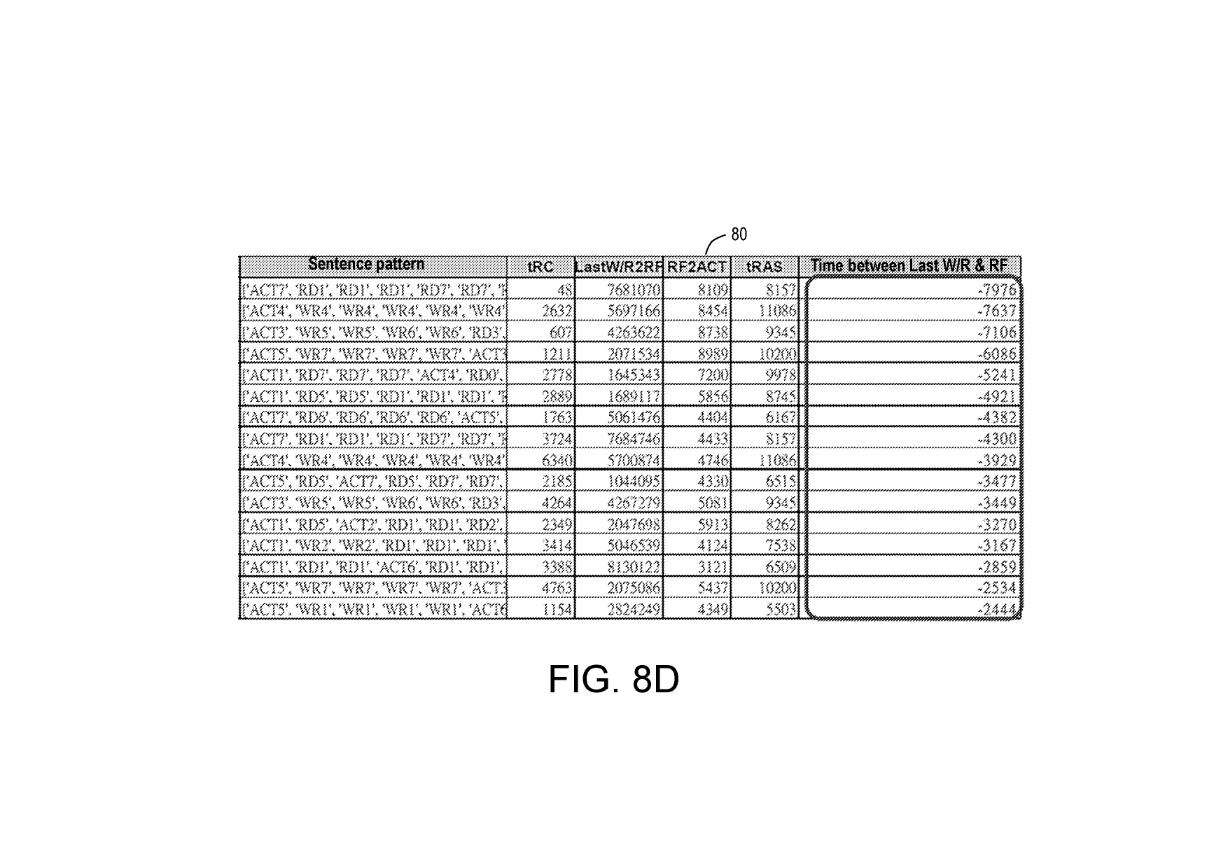

For example, FIGS. 8A to 8D are examples of calculating time parameters and using them to determine operating status according to embodiments of the disclosure. Referring to FIG. 8A, for the command sentence S1, this embodiment calculates the time between the head command ACT_3 and the first read command RDx_3 as the RAS to CAS delay (tRCD); calculates the time between the first read command RDx_3 and the second read command RDx_3 as the CAS to CAS delay (tCCD); and calculates the time between the second read command RDx_3 and the precharge command PRE_3 as the read to precharge time (tRTP). By calculating various time parameters of the command sentence S1 and performing statistics, it may be known from the statistical results whether there is any violation of component timing specification during the complex operation process.

For example, by calculating the time between the last read and write command W/R(bkn) in the command sentence and the refresh command REF, it may be determined whether the RAS precharge time (tRP) violates timing specification or other specifications.

Referring to FIG. 8B, for the command sentence S2, the calculated time T between the last read and write command W/R(bkn) and the refresh command REF is a positive number. From this, it may be confirmed that the RAS precharge time (tRP) does not violate timing specification.

Referring to FIG. 8C, for command sentence S3, the calculated time between the last read and write command W/R (bkn) and the refresh command REF is a negative number, which means that the refresh command REF will occur before the last read and write command W/R(bkn), therefore, there will be a situation where the memory bank (BK) is precharged (automatic precharged) before refreshing, and the read and write command W/R(bkn) after the refresh does not have the head command ACT. This confirms that the RAS precharge time (tRP) violates timing specification.

Referring to FIG. 8D, by calculating and compiling the time parameters of multiple command sentences, the operation mode of the application platform may be analyzed based on the numerical values or changes of these time parameters. For example, in the time parameter statistics table 80 of the command sentence, the time between the last read and write command W/R and the refresh command RF is a negative number. It may be seen that during the operation of the application platform, a situation in which the RAS precharge time (tRP) violates timing specification may occur.

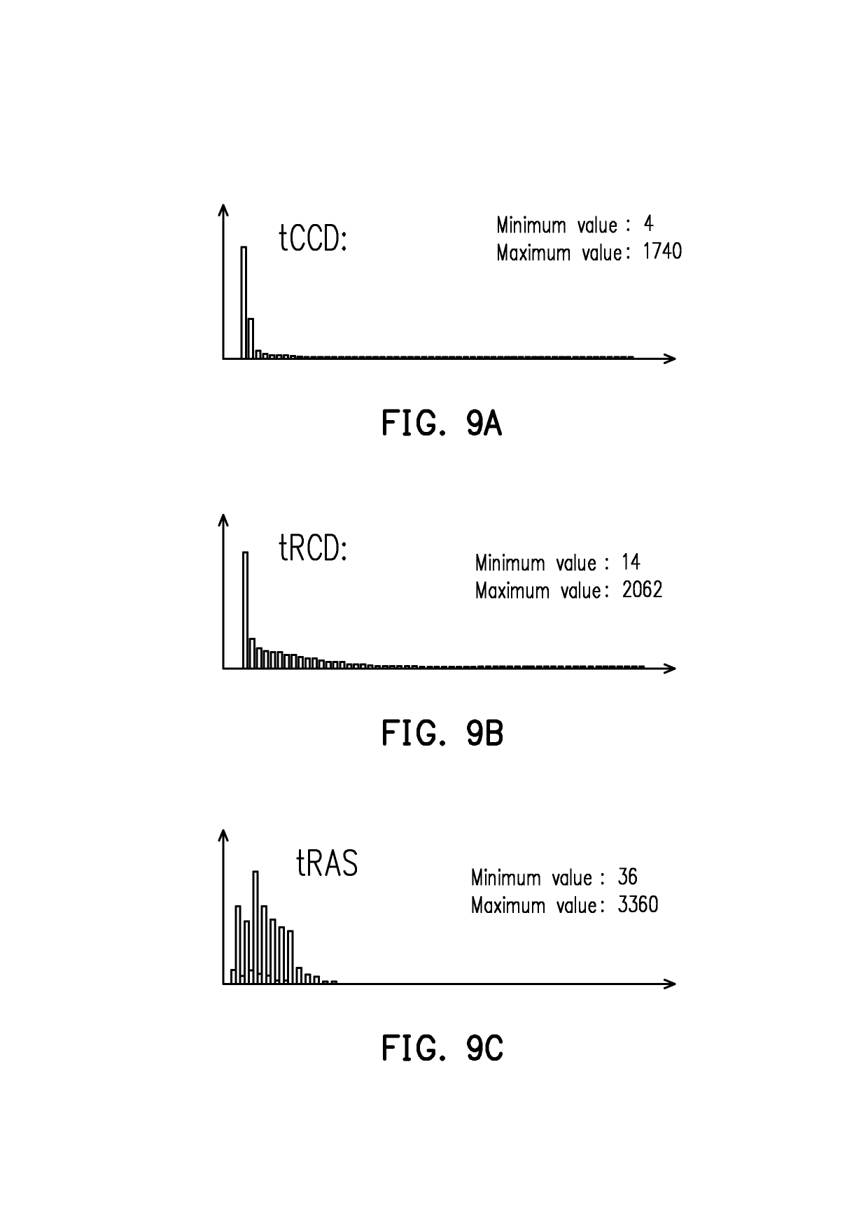

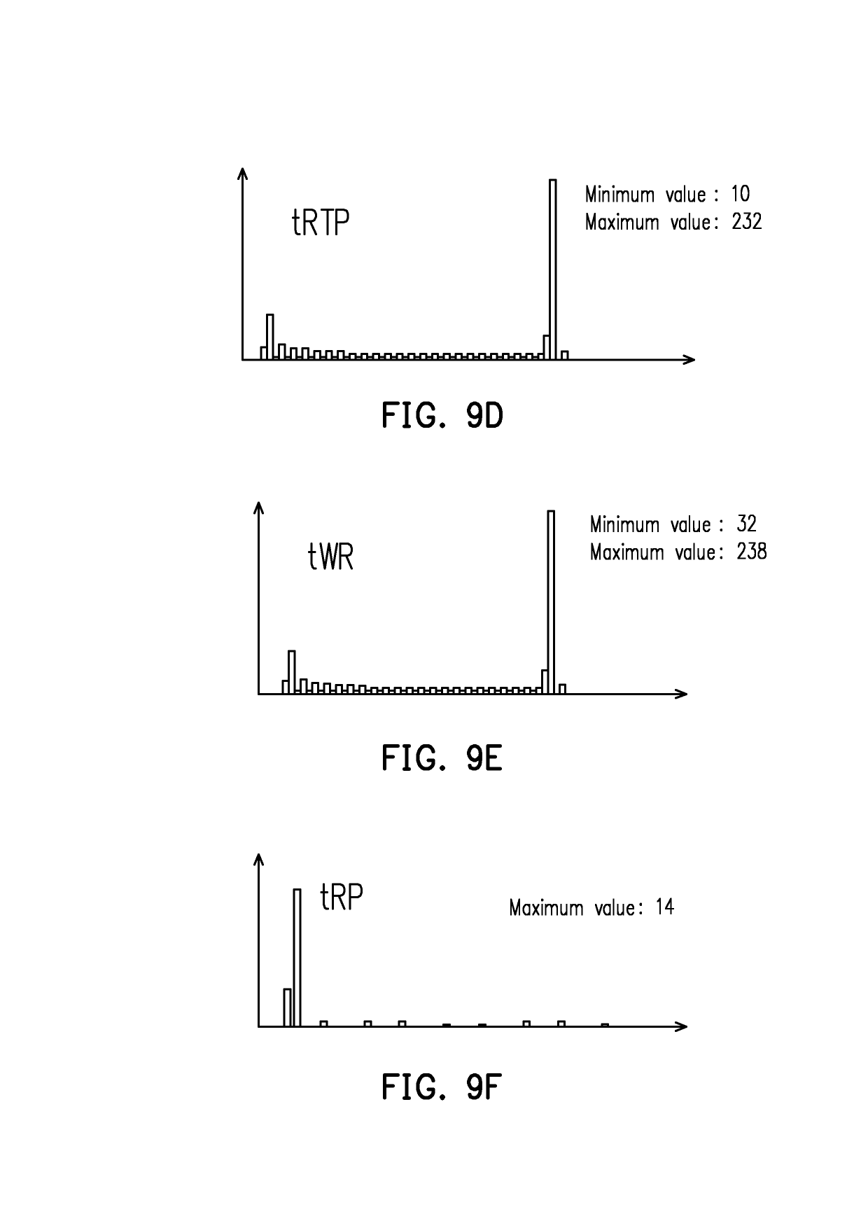

FIGS. 9A to 9F are examples of statistical results of time parameters according to embodiments of the disclosure. Referring to FIGS. 9A tp 9F, this embodiment illustrates the magnitude of various time parameters and statistical results of multiple command sentences found from the command sequence. FIG. 9A shows the statistical results of the CAS to CAS delay (tCCD), with a minimum value of 4 and a maximum value of 1740. FIG. 9B shows the statistical results of the RAS to CAS delay (tRCD), with a minimum value of 14 and a maximum value of 2062. FIG. 9C shows the statistical results of the RAS active time (tRAS), with a minimum value of 36 and a maximum value of 3360. FIG. 9D shows the statistical results of the read to precharge time (tRTP), with a minimum value of 10 and a maximum value of 232. FIG. 9E shows the statistical results of the write recovery time (tWR), with a minimum value of 32 and a maximum value of 238. FIG. 9F shows the statistical results of the RAS precharge time (tRP), with a minimum value of 14.

In this embodiment, through the above method, it may be known through the statistical results whether the application platform has violated the component timing specification or other specifications during the operation of the product.

It should be noted that, in addition to improving the efficiency of application platform fault analysis, the method of the embodiment of the disclosure may also provide engineers with the opportunity to further convert this information into a test program after understanding the operation mode of the application platform, and use it to test products on the application platform. Specifically, in the process of FIG. 3, after the processor 26 calculates the time parameters of each command sentence and performs statistics, the command sentence may be further converted into a test program suitable for testing the product by the application platform according to the statistical results. The processor 26 may generate a test program suitable for testing the product by the application platform by modifying the test pattern in the original test program or generating a new test pattern. As a result, test coverage may be increased.

To sum up, in the application platform operation mode analyzing method and apparatus of the disclosure, by finding and classifying into statistics various sentences of different definitions and lengths within the command sequence, and calculating various time parameters, it is possible to understand the structure of the command sequence and the important operation modes based on the frequency of appearance of commands of varying lengths. In addition, by calculating various time parameters of the found command sentence and performing statistics, it may be known whether there are violations of component timing specification or other specifications during the operation of the application platform on the product. Based on this statistical result, the command sentence may be converted into a test program suitable for testing the product by the application platform, thereby increasing the test coverage.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An application platform operation mode analyzing method, suitable for an electronic device having a processor, the method comprising:
capturing operation signals generated by application platform performing operations on a product, and converting the operation signals into a command sequence in a text form;
defining a plurality of operation combinations operated by the application platform on the product as target sentences to establish a sentence finding map according to a data sheet of the product;
scanning the command sequence by using N-gram algorithm according to each of the target sentences in the sentence finding map to find a plurality of command sentences in the command sequence that match the target sentences; and
calculating a plurality of time parameters of each of the command sentence and performing statistics on the command sentences, and outputting a statistical result of each of the command sentences in time series to simulate a operation mode of the application platform in each time series.

2. The application platform operation mode analyzing method according to claim 1, wherein capturing the operation signals generated by the application platform performing operations on the product comprising:
using a logic analyzer (LA) or an oscilloscope to capture the operating signals when the application platform is operating.

3. The application platform operation mode analyzing method according to claim 1, wherein converting the operation signals into the command sequence in the text form further comprising:
respectively adding the converted command sequence to a plurality of data layers according to type of the operation signals to establish a data cube comprising the data layers, the type comprising command, address, location or timing.

4. The application platform operation mode analyzing method according to claim 1, wherein each of the target sentences comprises at least one of a head command, a tail command, and a middle command.

5. The application platform operation mode analyzing method according to claim 1, wherein scanning the command sequence by using the N-gram algorithm according to each of the target sentences in the sentence finding map to find the command sentences in the command sequence that match the target sentences comprises:
selecting one of the target sentences;
scanning the command sequence by using a rolling window whose width is sequentially adjusted to find the command sentences in the rolling window that matches the selected target sentence, and adding the command sentences to a command sentence group; and
repeatedly executing the selecting and the scanning until the command sentences in the command sentence group reaches a predetermined condition, terminating the scanning.

6. The application platform operation mode analyzing method according to claim 5, wherein the predetermined condition comprises the command sentences in the command sentence group are not added or changed after a predetermined time or a predetermined scanning number.

7. The application platform operation mode analyzing method according to claim 1, wherein calculating the time parameters of each of the command sentence further comprises:
determining whether the application platform violates component specification of the product when performing operations on the product according to the calculated time parameters.

8. The application platform operation mode analyzing method according to claim 1, further comprising:
converting the command sentences into a test program suitable for testing the product by the application platform according to the statistical results.

9. The application platform operation mode analyzing method according to claim 1, wherein the product comprises a dynamic random access memory (DRAM), and the time parameters comprise RAS to CAS delay (tRCD), CAS to CAS delay (tCCD), read to precharge time (tRTP), RAS active time (tRAS), write recovery time (tWR), or RAS precharge time (tRP) of the dynamic random access memory.

10. The application platform operation mode analyzing method according to claim 1, wherein the statistical results comprise number or frequency of appearance of each of the command sentences.

11. An application platform operation mode analyzing apparatus, comprising:
a test data capturing device, capturing operation signals generated by application platform performing operations on a product;
a storage device; and
a processor, coupled to the test data capturing device and the storage device, and configured to:
convert the operation signals captured by the test data capturing device into a command sequence in a text form;
define a plurality of operation combinations operated by the application platform on the product as target sentences to establish a sentence finding map according to a data sheet of the product and store the sentence finding map in the storage device;
scan the command sequence by using N-gram algorithm according to each of the target sentences in the sentence finding map to find a plurality of command sentences in the command sequence that match the target sentences; and
calculate a plurality of time parameters of each of the command sentence and perform statistics on the command sentences, and output a statistical result of each of the command sentences in time series to simulate a operation mode of the application platform in each time series.

12. The application platform operation mode analyzing apparatus according to claim 11, wherein the test data capturing device comprises a logic analyzer or an oscilloscope.

13. The application platform operation mode analyzing apparatus according to claim 11, wherein the processor further respectively adds the converted command sequence to a plurality of data layers according to type of the operation signals to establish a data cube comprising the data layers, the type comprises command, address, location or timing.

14. The application platform operation mode analyzing apparatus according to claim 11, wherein each of the target sentences comprises at least one of a head command, a tail command, and a middle command.

15. The application platform operation mode analyzing apparatus according to claim 11, wherein the processor comprises selecting one of the target sentences, scanning the command sequence by using a rolling window whose width is sequentially adjusted to find the command sentences in the rolling window that matches the selected target sentence, and adding the command sentences to a command sentence group, and repeatedly executing the selecting and the scanning until the command sentences in the command sentence group reaches a predetermined condition, terminating the scanning.

16. The application platform operation mode analyzing apparatus according to claim 15, wherein the predetermined condition comprises the command sentences in the command sentence group are not added or changed after a predetermined time or a predetermined scanning number.

17. The application platform operation mode analyzing apparatus according to claim 11, wherein the processor further determines whether the application platform violates component specification of the product when performing operations on the product according to the calculated time parameters.

18. The application platform operation mode analyzing apparatus according to claim 11, wherein the processor further converts the command sentences into a test program suitable for testing the product by the application platform according to the statistical results.

19. The application platform operation mode analyzing apparatus according to claim 11, wherein the product comprises a dynamic random access memory, and the time parameters comprise RAS to CAS delay, CAS to CAS delay, read to precharge time, RAS active time, write recovery time, or RAS precharge time of the dynamic random access memory.

20. The application platform operation mode analyzing apparatus according to claim 11, wherein the statistical results comprise number or frequency of appearance of each of the command sentences.
